(19) United States
(12) Patent Application Publication
(10) Pub. No.: US 2019/0121511 A1
(43) Pub. Date: Apr. 25, 2019

(54) METHOD AND SYSTEM FOR FACILITATING SEARCHING OF DIGITAL FILES ASSOCIATED WITH A STORAGE ACCOUNT

(71) Applicant: Dittach, LLC,, New York, NY (US)

(72) Inventors: David Gelernter, Woodbridge, CT (US); Daniel Gelernter, New York, NY (US); Ivan Fan, Appleton, WI (US); Adam Stern, Bronx, NY (US)

(73) Assignee: Dittach, LLC,, New York, NY (US)

(21) Appl. No.: 15/788,687

(22) Filed: Oct. 19, 2017

(51) Int. Cl. G06F 3/0485; G06F 17/30; G06F 3/0481; H04L 12/58

(52) U.S. Cl. CPC G06F 3/0485; G06F 17/30106; G06F 17/30091; H04L 67/36; G06F 3/04817; H04L 51/08; H04L 51/16; G06F 17/30126

(57) ABSTRACT

Disclosed is a method of facilitating searching of digital files associated with one or more storage accounts. The method may include receiving, using a communication device, a search criterion from a user device. Further, the method may include retrieving, using a storage device, a plurality of identifiers and previews associated with a plurality of digital files based on the search criterion. Further, the method may include a step of transmitting, using the communication device, the plurality of identifiers and previews to the user device. Further, the user device may be configured to display a scrollable feed including the plurality of identifiers and previews. Further, the plurality of identifiers and previews may be sorted according to a plurality of time-stamps associated with the plurality of identifiers. Further, the scrollable feed may include a time based scroller configured to receive a scrolling action and accordingly update the scrollable feed.

### FIELD OF DISCLOSURE

The present disclosure generally relates to digital data processing. More specifically, the disclosure relates to method and system for facilitating searching of digital files associated with a storage account.

### BACKGROUND

Today's internet user has data scattered across a vast array of online platforms. The data includes documents, photos, movies, and other digital items. The online platforms may be expressly dedicated to storage, like OneDrive or Dropbox, or they may store a user's digital items as part of delivering a broader service, like Facebook storing photos and videos, or Gmail and other email clients storing files as attachments.

It is often difficult to find files, media, and other digital items, especially when the platform does not expose the digital items to be directly browseable and/or searchable by the user. For instance, most platforms do not allow the user to browse and search email attachments directly. The user has to search for an email rather than a file, then select an email containing an attachment, and then select the attachment.

The problem gets much worse when one considers that to find a particular digital item, the user has to struggle not only with finding it on a particular platform, but with remembering on which platform the digital item was stored.

Further, while most online storage services provide a search interface to enable users to search content, they suffer from a several drawbacks. Firstly, users typically store digital content on multiple online storage accounts. However, there is no common search interface that enables users to search for digital content on multiple online storage accounts. As a result, users are burdened with the task of performing separate searches on the search interfaces corresponding to the multiple storage accounts.

Further, there are several technical challenges involved in providing such a common search interface. For example, creating a central repository of all digital contents associated with a user is impractical and formidably expensive. Both the creation and regular updation of the central repository is computationally intensive and is therefore not a scalable solution. Moreover, due to privacy and data-protection issues, users are generally unwilling to allow bulk copying of digital content from their preferred online storage onto the central repository.

Secondly, due to inexpensive availability of storage space, users are storing an unprecedented amount of data both online and offline. As a result, finding a digital item of interest is a daunting task for users. For instance, upon executing a search, most online storage services return a large number of results potentially including the digital item of interest. However, wading through these results to locate the digital item of interest is both frustrating and time consuming for users. In particular, existing technologies fail to provide an intuitive user interface that enables users to quickly and effortlessly locate the digital item of interest.

Accordingly, there is a need for improved methods and systems for facilitating searching of digital files associated with one or more storage accounts that can overcome one or more of the abovementioned problems and/or limitations.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope

According to some embodiments, a method of facilitating searching of digital files associated with one or more storage accounts based on a search criterion received from a user device is provided. The method may include a step of receiving, using a communication device, a search criterion from a user device. In some embodiments, the search criterion may be received within a search interface associated with a storage account of the at least one storage account. Further, the search interface may be configured to initiate a content search for digital content associated with the storage account based on the search criterion. Further, the content search may be performed based on a second search index associated with the storage account.

Further, the method may include a step of retrieving, using a storage device, a plurality of identifiers associated with a plurality of digital files based on the search criterion. Further, the storage device may include a first search index of digital files associated with the at least one storage account. Further, the method may include a step of retrieving, using the storage device, a plurality of previews associated with the plurality of digital files based on the plurality of identifiers. Further, the method may include a step of transmitting, using the communication device, each of the plurality of identifiers and the plurality of previews to the user device. Further, the user device may be configured to display a scrollable feed including the plurality of identifiers and the plurality of previews. Further, the plurality of identifiers may be sorted according to a plurality of time-stamps associated with the plurality of identifiers. Further, the scrollable feed may include a scroller configured to receive a scrolling action. Further, the scrollable feed may be updated based on the scrolling action. Further, the scrollable feed further may include a time indicator configured to display a time indication associated with a portion of the plurality of identifiers and the plurality of previews currently displayed on the user device.

Further, in accordance with some embodiments, a system for facilitating searching of digital files associated with at least one storage account is provided. The system may include a communication device configured to receive a search criterion from a user device. Further, the communication device may be configured to transmit each of a plurality of identifiers and a plurality of previews to the user device. Further, the user device may be configured to display a scrollable feed comprising the plurality of identifiers and the plurality of previews. Further, the plurality of identifiers may be sorted according to a plurality of time-stamps associated with the plurality of identifiers. Further, the scrollable feed may include a scroller configured to receive a scrolling action. Further, the scrollable feed may be updated based on the scrolling action. Further, the scrollable feed may include a time indicator configured to display a time indication associated with a portion of the plurality of identifiers and the plurality of previews currently displayed on the user device. Additionally, the system may include a storage device configured to retrieve the plurality of identifiers associated with the plurality of digital files based on the search criterion. Further, the storage device may include a first search index of digital files associated with the at least one storage account. Additionally, the storage device may be configured to retrieve the plurality of previews associated with the plurality of digital files based on the plurality of identifiers.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a block diagram of an operating environment consistent with the present disclosure.

FIG. 2 illustrates a system for facilitating searching of digital files associated with one or more storage accounts, in accordance with some embodiments.

FIG. 3 illustrates a user interface 300 for facilitating searching of digital files associated with one or more storage accounts, in accordance with some embodiments. The user interface 300 includes a scrollable feed comprising a plurality of identifiers associated with a plurality of digital files and a plurality of previews associated with the plurality of digital files.

FIG. 4 illustrates a user interface 400 for facilitating searching of digital files associated with one or more storage accounts including display of a full-view of a selected digital file, in accordance with some embodiments. Further, the user interface 400 includes GUI elements configured to enable one or more operations (e.g. view an associated email, download the digital file to local storage, forward the digital file as an attachment, print the digital file etc.) to be performed on the selected digital file.

FIG. 5 illustrates a user interface 500 for facilitating searching of digital files associated with one or more storage accounts including display of an email associated with a selected digital file, in accordance with some embodiments. Further, the email may include the selected digital file as an attachment.

FIG. 6 illustrates a user interface 600 for facilitating searching of digital files associated with one or more storage accounts including a forwarding icon configured to forward a selected digital file as an email attachment, in accordance with some embodiments. Further, the user interface 600 may also display the email including the selected digital file. Additionally, the user interface 600 may be configured to display an email forwarding window in response to activation of the forwarding icon.

FIG. 7 illustrates a user interface 700 for facilitating searching of digital files associated with one or more storage accounts including a plurality of filters, in accordance with some embodiments. Further, the plurality of digital files and the plurality of previews may be selectively displayed in the scrollable feed based on selection of one or more filters of the plurality of filters.

FIG. 8 illustrates a user interface 800 for facilitating searching of digital files associated with one or more storage accounts including a date scroll element, in accordance with some embodiments. Further, a user interface 800 may be configured to update the scrollable feed comprising the plurality of digital files and the plurality of previews based on a user interaction with the date scroll element. Additionally, a time (e.g. date) value associated with the date scroll element may be displayed.

FIG. 9 illustrates a user interface 900 for facilitating searching of digital files associated with one or more storage accounts including a search bar, in accordance with some embodiments. Further, the user interface 900 may include an email client interface. Furthermore, the user interface 900 may be configured to receive a search criterion in the search bar and display a plurality of digital files and a corresponding plurality of previews within the scrollable feed based on the search criterion. Additionally, the user interface 900 may also be configured to display emails corresponding to the search criterion within the email client interface.

FIG. 10 illustrates a flowchart of a method 1000 of facilitating searching of digital files associated with one or more storage accounts based on a search criterion received from a user device, in accordance with some embodiments. The method includes transmitting a plurality of digital files and a corresponding plurality of previews to the user device. Further, the plurality of digital files and the plurality of previews may be displayed on the user device within a scrollable feed.

FIG. 11 illustrates a flowchart of a method 1100 of facilitating searching of digital files associated with one or more storage accounts including transmitting full-content of a selected digital file and/or a source indictor of the selected digital file, in accordance with some embodiments. The selected digital file may be identified based on a selection in the scrollable feed comprising the plurality of digital files and the plurality of previews. Further, the source indicator may specify a storage location (e.g. storage account name, file path, email associated with the selected digital file etc.) which includes the selected digital file.

FIG. 12 illustrates a flowchart of a method 1200 of facilitating searching of digital files associated with one or more storage accounts including transmitting of full-content of a digital file based on a file request received from a user device. Further, the method 1200 include transmitting the file request to a storage server and receiving the full-content from the storage server.

FIG. 13 illustrates a flowchart of a method 1300 of facilitating searching of digital files associated with one or more storage accounts including generation of a search index based on authenticated communication with one or more storage servers associated with one or more storage accounts, in accordance with some embodiments.

FIG. 14 illustrates a flowchart of a method 1400 of facilitating searching of digital files associated with one or more storage accounts including generation of a search index based on one or more privacy rules, in accordance with some embodiments.

FIG. 15 illustrates a block diagram of a system 1500 for implementing various methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of searching of digital files associated with a storage account, embodiments of the present disclosure are not limited to use only in this context.

### I. Platform Overview

Consistent with embodiments of the present disclosure, an online platform (also referred to herein as “search platform” or “the Dittach platform”) for facilitating searching of digital files associated with one or more storage accounts may be provided. This overview is provided to introduce a selection of concepts in a simplified form that are further described below. This overview is not intended to identify key features or essential features of the claimed subject matter. Nor is this overview intended to be used to limit the claimed subject matter's scope. The online platform may be used by individuals or companies to facilitate searching of digital files.

In accordance with some embodiments, the online platform provides a means of aggregating, displaying and permitting user interaction with data from one or more external sources. Further, the data may be made searchable and/or browseable and presented to the user either in a standalone application and/or as a plugin or add-on to an existing application.

An objective of the online platform is to not only provide access to digital items associated with a user across multiple storage accounts but to also provide an easy access. Accordingly, the design of the interface (UI) and the user experience (UX) may be configured to make it easy for a user to manage the digital items. Further, in some instances, the online platform may not use a file and folder-based system. Accordingly, the online platform may translate folders into tags to be applied to digital items. However, no folders may be maintained. Further, the online platform may be based on search. Accordingly, results may not be required to be stored in any particular folder or on any particular platform.

Further, the online platform may not duplicate digital items of users from other storage platforms. Accordingly, in some instances, the online platform may function as a unifying platform or an abstraction layer on top of other platforms. As a result, the online platform may provide a single access point to all digital items of a user, so that the user need not consider what platform the user was using when the user received and/or sent a particular digital item.

Accordingly, in some instances, the online platform may provide a feed of digital items belonging to a user and may allow the user to interact with the digital items. In particular, the online platform may enable the user to search both metadata and full content of the digital items. Further, the online platform may enable the user to view thumbnails—that is, small images—of the digital items without having to select a digital item first. Accordingly, by allowing the user to see thumbnails of every digital item (including non-image files such as PDF, text file, presentation slides, spreadsheet, etc.) the user may be greatly aided in finding a desired content, and in discovering content which the user would otherwise not have seen and/or ignored.

In some instances, the online platform may not be limited to any one source of digital content. The online platform may be able to ingest digital items from one or more online sources, so long as a source has an available API. Further, the online platform may not duplicate digital items from an online source onto the online platform. In other words, the online platform may store only an index and thumbnails corresponding to digital items. Accordingly, the online platform may function efficiently in terms of storage space and/or computation. Further, in case the user wants to interact with a digital item—say by downloading it—the online platform can retrieve the digital item directly from whatever platform it was originally stored on and provide the digital item to the user.

Further, in some instances, the scrollable feed of digital items may be limited to one storage account. For example, the online platform may provide a feed of attachments for an email service (e.g. Gmail, Outlook Mail, AOL mail, Yahoo Mail, etc.) that allows a user to browse, search and interact with the files associated with an email account of the user. Further, this functionality may be provided in the form of a standalone application, or as a plugin. For example, the online platform may provide the user with a feed displayed as a column of digital items, shown to the side of emails, each item being represented by a thumbnail and meta data, such as title, sender, file size, file type, etc.

Further, in some instances, the scrollable feed of digital items may incorporate digital items from different types of storage (online and offline) and still be displayed within or as an extension or plugin to a single platform. For example, in the scrollable feed displayed in the context of the email service, the scrollable feed may include not only email attachments, but also files stored in Cloud Storage platforms such as Drive, Dropbox etc., social platforms like

Facebook, Instagram etc., collaboration platforms like Slack, ZOHO etc. and local storage of a user device (laptop, smartphone etc.) through which the user accesses the online platform.

Further, the design of the user interface (UI) and the user experience (UX) provided by the online platform may make is easy for a user to perform actions and use the online platform without a steep learning curve. The operations are intuitive, the number of controls are limited and the design is deliberately aimed at users who do not have the time to learn a new way of digital item management. In particular, this is provided by basing the arrangement on a search feed, as opposed to a file and folder structure.

Further, the scrollable feed may include not only the ability to filter items by particular platform, but also by file type, sent vs received, and so forth.

Further, the scrollable feed may include a ‘date scroller’ that allows users to rapidly go to a particular date without having to use a calendar or type in a date.

Further, the scrollable feed may also include digital items that represent links or URLs to videos, websites and other files that were shared in a message.

Further, users can select a digital item to view more information, see larger images, or perform operations on the digital item. These operations may include, but are not limited to, download, print, share, edit, or view email.

Further, the online platform may also enable the user to save or copy digital items on the online platform, or to delete a digital item from the original platform (for example, to delete an attachment from email), to secure or encrypt a digital item, to add tags and descriptions to the digital items available on the online platform, upload files directly to the online platform and share with other users.

### II. Platform Configuration

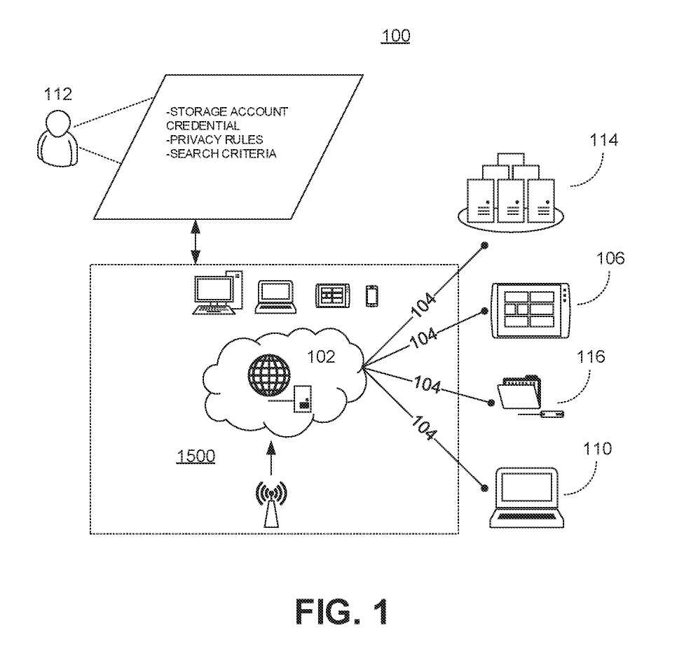

FIG. 1 is an illustration of a platform consistent with various embodiments of the present disclosure. By way of non-limiting example, the online platform 100 for facilitating searching of digital files associated with one or more storage accounts may be hosted on a centralized server 102, such as, for example, a cloud computing service. The centralized server may communicate with other network entities, such as, for example, a user device 106 or 110 (such as a smartphone, a laptop, a tablet computer, a desktop computer, a wearable computer etc.) operated by a user 112, an application server 114 (e.g. email server, social media server etc.) and a file server 116 (e.g. online storage server) over a communication network 104, such as, but not limited to, the Internet.

A user 112, may access platform 100 through a software application. The software application may be embodied as, for example, but not be limited to, a website, a web application, a desktop application, and a mobile application compatible with a computing device 1500. One possible embodiment of the software application may be provided by Dittach™ products and services.

Accordingly, in an instance, the user 112 may access the platform in order to browse and/or search for digital files that may be stored at one or more storage locations, such as for example, but not limited to, an online storage service (e.g. Dropbox, Drive etc.), a social media server (e.g. Facebook, Instagram etc.), a local storage (e.g. storage included in user device 106 or 110).

In an instance, the online platform may generate a user interface displayable on the user device 106 or 110. The user interface may include a scrollable feed including a plurality of identifiers (e.g. file names) and a plurality of previews (e.g. thumbnails) associated with the digital files. Further, the scrollable feed may also display additional metadata associated with the digital files such as creation date, last modified date, size, file type, name of sender, name of recipient and environmental variables associated with the digital file such as location and time.

Further, in an instance, the scrollable feed may be integrated within a GUI of a primary application. Accordingly, the online platform may provide a plugin configured to interact with the primary application in order to display the scrollable feed. For example, in an instance, the scrollable feed may be presented within a GUI of an email client interface. Accordingly, the scrollable feed may include digital files associated with an email account of the user 112. Further, in some embodiments, the scrollable feed may also include digital files associated with other storage accounts of the user (e.g. Dropbox, Drive, iCloud etc.).

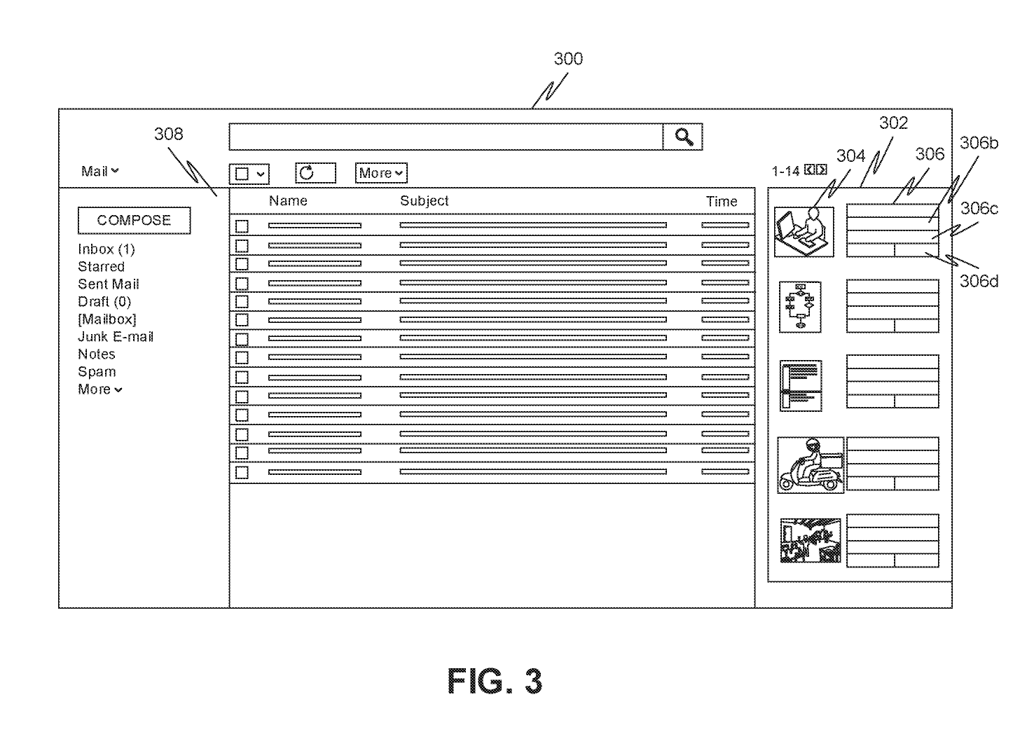

For example, FIG. 3 illustrates a user interface 300 for facilitating searching of digital files associated with one or more storage accounts, in accordance with some embodiments. The user interface 300 may include a scrollable feed 302 comprising a plurality of identifiers 306 associated with a plurality of digital files and a plurality of previews 304 associated with the plurality of digital files. In addition, the plurality of identifiers (306a, 306b, 306c and 306d) may include, for example, but without limitation, file name, file size, file type, a textual snippet and so on.

The user interface 300 may further include an email interface 308 configured to enable the user 112 to perform one or more operations (view email, compose email, send email etc.) in relation to an email account.

Further, the previews may include a visual snapshot of content of the digital files. For example, the preview may be a visual snapshot of the cover page of a digital file. In some instances, the visual snapshot may be of a page that is representative of content of the digital file. Accordingly, in some embodiments, the online platform may perform semantic analysis of the digital file in order to determine the representative page. Further, in some embodiments, the representative page may be determined based on previous user interactions while viewing the digital file. For example, based on an amount of viewing time associated with a page, the online platform may determine the page to be significant and/or representative of the digital file.

The display of previews associated with the digital files may enable the user to browse the digital files in an intuitive manner. Further, the scrollable feed may be configured to receive a selection of an identifier of the plurality of identifiers from the user 112. Accordingly, the online platform may transmit the full-content version of the digital file associated the identifier to the user device 106. In an instance, the online platform may communicate with a storage server (E.g. application server 114 or file server 116) in order to retrieve the full-content version. In other words, the online platform may mediate transfer of the full-content version from an original storage location to the user device 106.

Additionally, in some embodiments, the scrollable feed may further include a form-factor selector configured to select a form-factor from a plurality of form-factors. Further, the scrollable feed corresponding to a first form-factor may consist of the plurality of identifiers and the plurality of metadata. Accordingly, the user may be presented with a text-only view of the scrollable feed. In other words, in some embodiments, the scrollable feed may include only the file names and one or more metadata such as (a date, sender name, recipient name, a file type and a file size etc.).

Furthermore, the scrollable feed corresponding to a second form-factor may consist of the plurality of previews. Accordingly, the user may be presented with an image-only view of the scrollable feed. In other words, in some embodiments, the scrollable feed may include only the previews (e.g. visual snapshots) and optionally one or more key metadata such as (a date, sender name, recipient name, etc.).

Additionally, the scrollable feed corresponding to a third form-factor may consist of each of the plurality of identifiers, the plurality of previews and the plurality of metadata. Accordingly, the user may be presented with a detailed-view of the scrollable feed. In other words, in some embodiments, the scrollable feed may include, for each digital file, a file name, a thumbnail of the file and metadata of the file.

Further, in some embodiments, the form-factor selector may include separate GUI elements corresponding to the plurality of form-factors. For example, three GUI elements may be provided corresponding to the first form-factor, the second form-factor and the third form-factor. Alternatively, in some embodiments, the form-factor selector may include a single GUI element that may be activated cyclically in order to select through the plurality of form-factors.

For example, in a default view, the scrollable feed may be presented as per the third form-factor (i.e. detailed-view). Further, a first activation of the form-factor selector may cause presentation of the scrollable feed as per the first form-factor (i.e. “text-only view”). Furthermore, a subsequent second activation of the form-factor selector may cause presentation of the scrollable feed as per the second form-factor (i.e. “image-only view”). Further, a subsequent third activation of the form-factor selector may cause presentation of the scrollable feed as per the third form-factor (i.e. detailed-view).

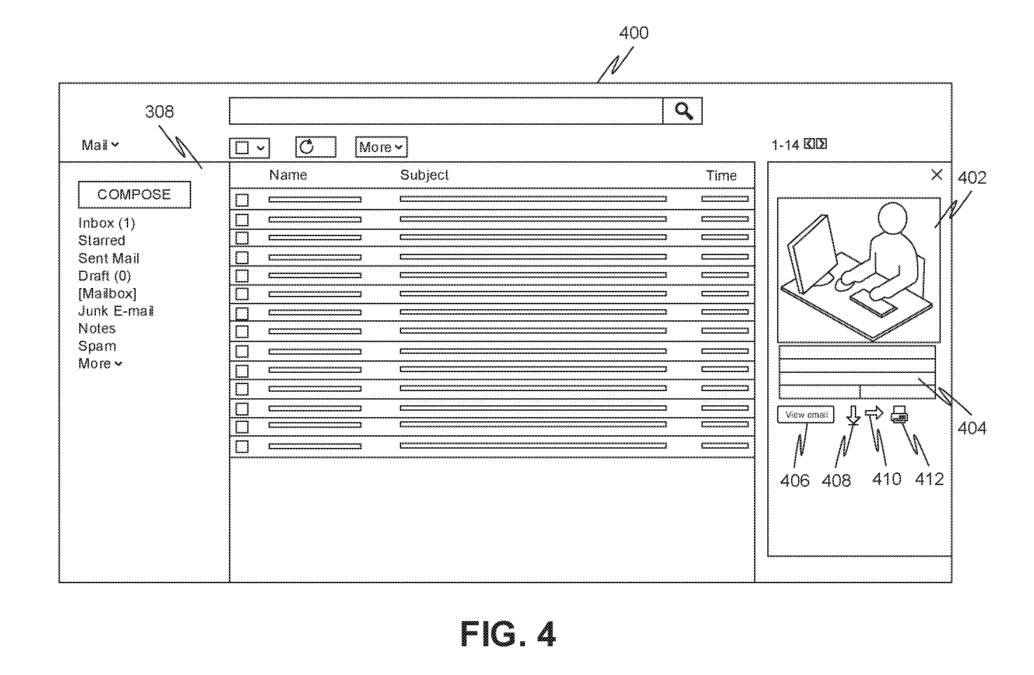

For example, FIG. 4 illustrates a user interface 400 for facilitating searching of digital files associated with one or more storage accounts including display of a full-view 402 of a selected digital file, in accordance with some embodiments. Additionally, in some embodiments, additional metadata 404 may be displayed along with the full-view 402. Further, the user interface 400 may include GUI elements 406, 408, 410 and 412 configured to enable corresponding operations of view an associated email, download the digital file to local storage, forward the digital file as an attachment, print the digital file respectively to be performed on the selected digital file.

Accordingly, in some embodiments, the scrollable feed may include a view-email icon (such as 406). Further, activation of the view-email icon may cause displaying of the at least one email. Accordingly, in an instance, upon receiving an indication of activation of the view-email icon, the online platform may interact with an email server in order to retrieve and present the at least one email associated with the digital file selected by the user.

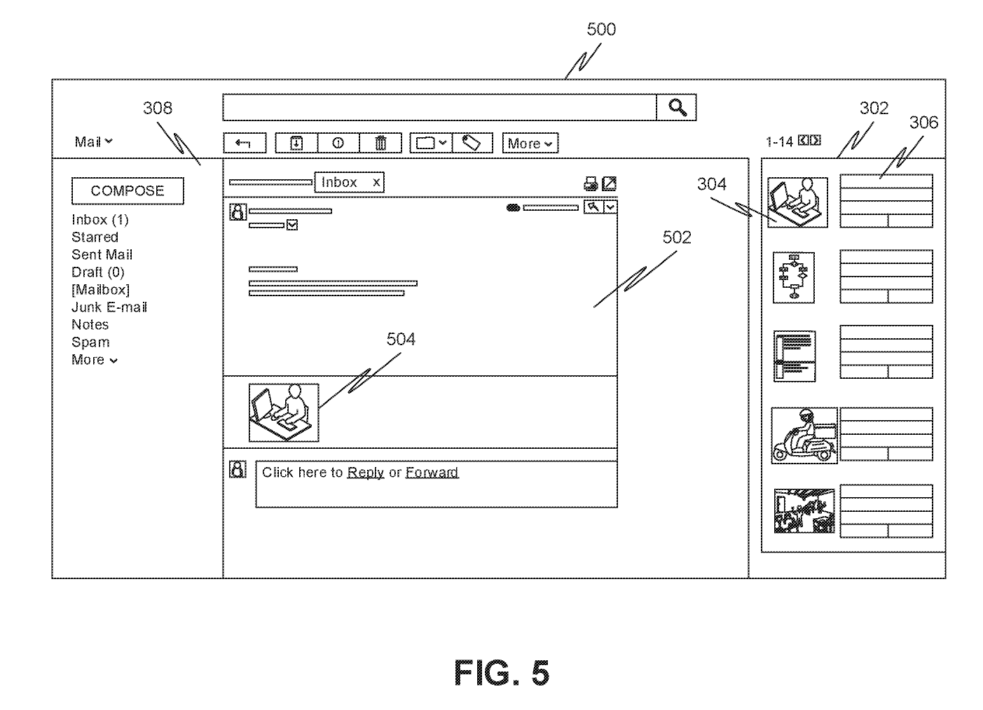

For example, FIG. 5 illustrates a user interface 500 for facilitating searching of digital files associated with one or more storage accounts including display of an email 502 associated with a selected digital file 504, in accordance with some embodiments. Further, the email 502 may include the selected digital file as an attachment.

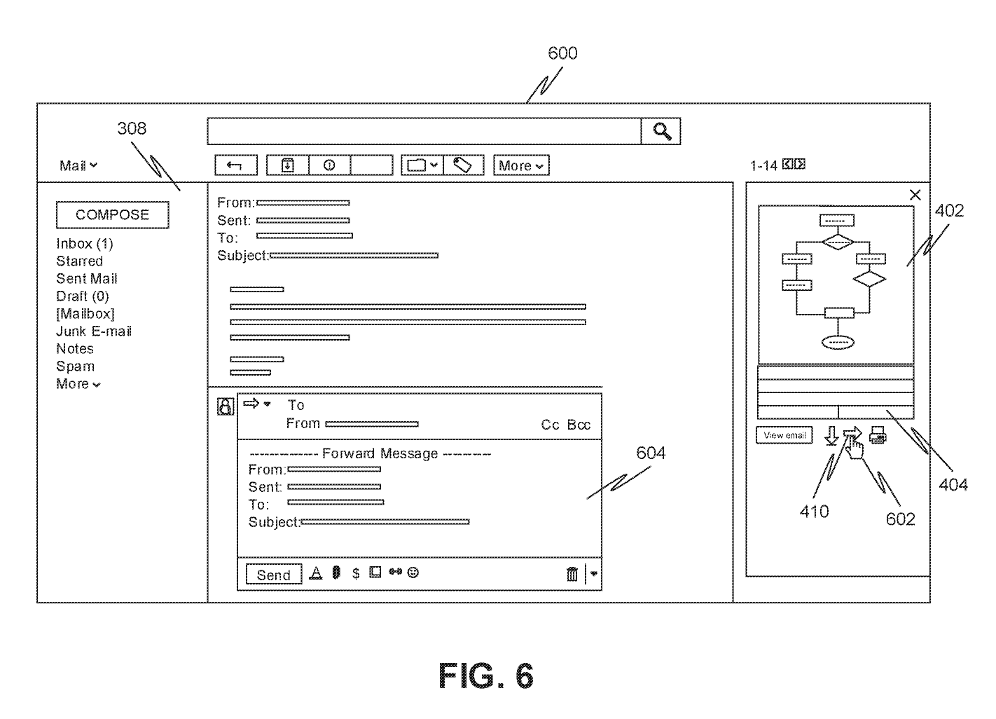

As another example, FIG. 6 illustrates a user interface 600 for facilitating searching of digital files associated with one or more storage accounts including a forwarding icon 410 configured to forward a selected digital file 402 as an email attachment, in accordance with some embodiments. Further, the user interface 600 may also display the email including the selected digital file. Additionally, the user interface 600 may be configured to display an email forwarding window 604 in response to activation 602 (e.g. click operation, touch operation, etc.)

of the forwarding icon 410. Further in some embodiments, the forwarding icon 410 may be configured to forward the selected digital file 402 through one or more other applications such as, but not limited to, a file-sharing application, a social network, a cloud storage service and a text-messaging application (e.g. SMS, Whatsapp etc.).

Further, the scrollable feed may also include GUI elements to facilitate the user 112 to perform one or more operations on a digital file that may be effected on a corresponding original storage account. The one or more operations may include, but are not limited to, downloading, forwarding, viewing an email associated with a digital file, sharing with one or more other users, printing, deleting and editing.

Additionally, the user interface may include one or more filters in order facilitate the user 112 to selectively view digital files within the scrollable feed. For example, a plurality of filters based on file types (e.g. photos, word documents, spreadsheets, presentation slides, PDFs, Videos, executable files, music etc.) may be provided. Further, in the context of digital files sent by the user to one or more other users and/or received from one or more other users, the plurality of filters may also include one or more of “received” and “sent”. Accordingly, upon selection of a filter, the scrollable feed may be configured to update the plurality of identifiers and the plurality of previews based on the filter.

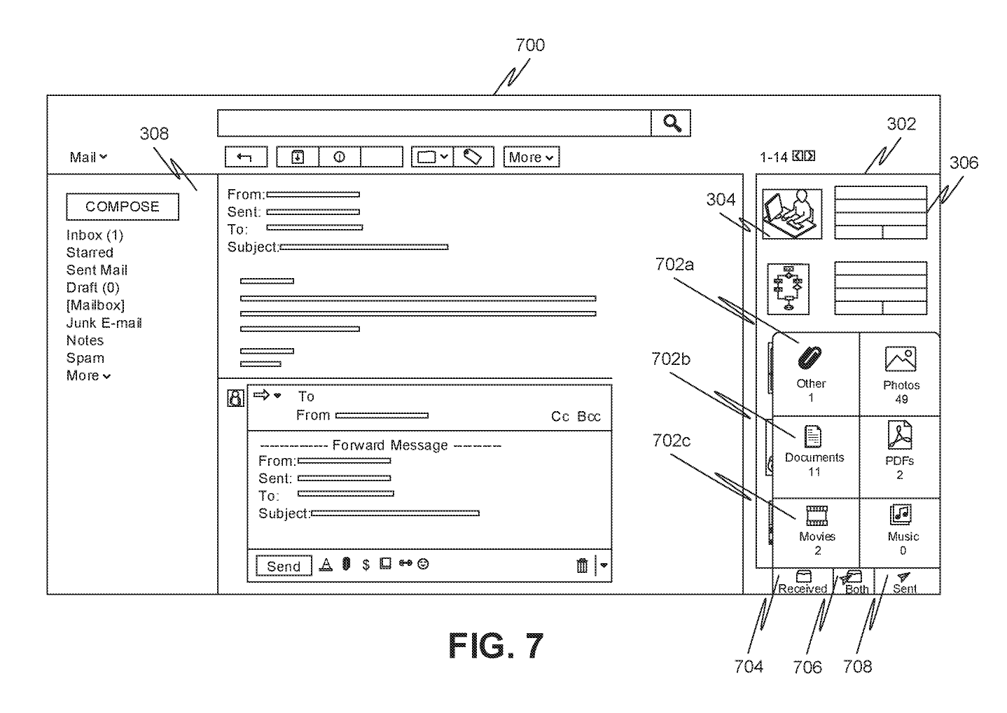

For example, FIG. 7 illustrates a user interface 700 for facilitating searching of digital files associated with one or more storage accounts including a plurality of filters 702, in accordance with some embodiments. Further, the plurality of identifiers 306 and the plurality of previews 304 may be selectively displayed in the scrollable feed 302 based on selection of one or more filters 702 of the plurality of filters 702. Further, the plurality of filters 702 (i.e. 702d, 702e and 702f) may also be based on “sent”, “received” and “send and received”.

Further, the user interface may include a time based scroller configured to facilitating scrolling of the scrollable feed. In an instance, the time based scroller may include display of a time value (e.g. date) associated with time values corresponding to the plurality of digital files whose corresponding identifiers are currently in view within the scrollable feed. For example, the time value displayed in the time based scroller may be the median of time values associated with the plurality of digital files. Further, a scrolling action on the time based scroller may update both the time value displayed within the time based scroller and also the plurality of digital identifiers within the scrollable feed. As a result, the user 112 may be enabled to intuitive and quickly navigate to digital files associated with a time frame.

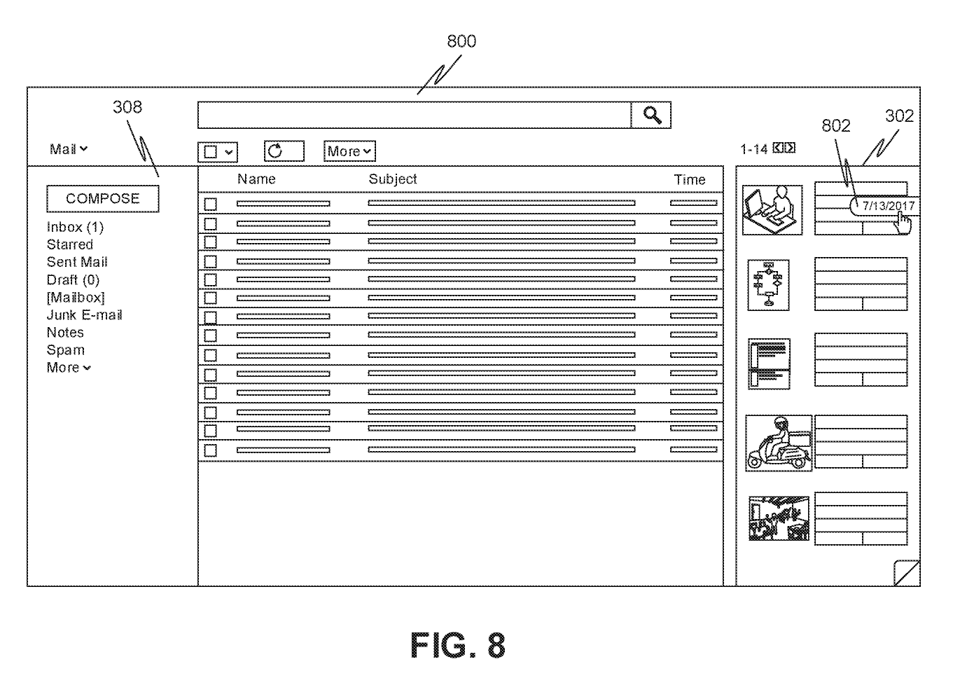

For example, FIG. 8 illustrates a user interface 800 for facilitating searching of digital files associated with one or more storage accounts including a date scroll element 802, in accordance with some embodiments. Further, a user interface 800 may be configured to update the scrollable feed 302 comprising the plurality of digital identifiers 306 and the plurality of previews 306 based on a user interaction with the date scroll element 802. Additionally, a time (e.g. date) value associated with the date scroll element may be displayed. The time value, such as a date, may correspond to dates associated with the digital files whose corresponding identifiers are currently in view within the scrollable feed 302.

Further, the user interface may include a search interface configured to receive a search criterion from the user and perform a search on the plurality of digital files associated with the user 112. Further, in an instance, the GUI of the primary application may include a native search interface for searching of digital content associated with the primary application. Accordingly, in some embodiments, the online platform may integrate with the primary application in order to receive the search criterion entered into the native search interface. For example, search keywords entered into a search bar of an email client interface may be received and used to search within the plurality digital files associated with the user 112. Accordingly, the online platform may generate and maintain a first search index associated with the plurality of digital files. Further, in some embodiments, the search index may include the plurality of previews associated with the plurality of digital files. Accordingly, a first search may be conducted on the first search index based on the search keywords. Further, based on results of the first search, the scrollable feed may be updated to include the plurality of identifiers of the plurality of digital files containing the search keywords and/or related words thereof (e.g. synonyms). Additionally, based on the search keywords, the primary application (e.g. email client interface) may also conduct a second search over a second index corresponding to digital content (e.g. emails) associated with the primary application. Accordingly, the user interface may also be configured to display results of the second search.

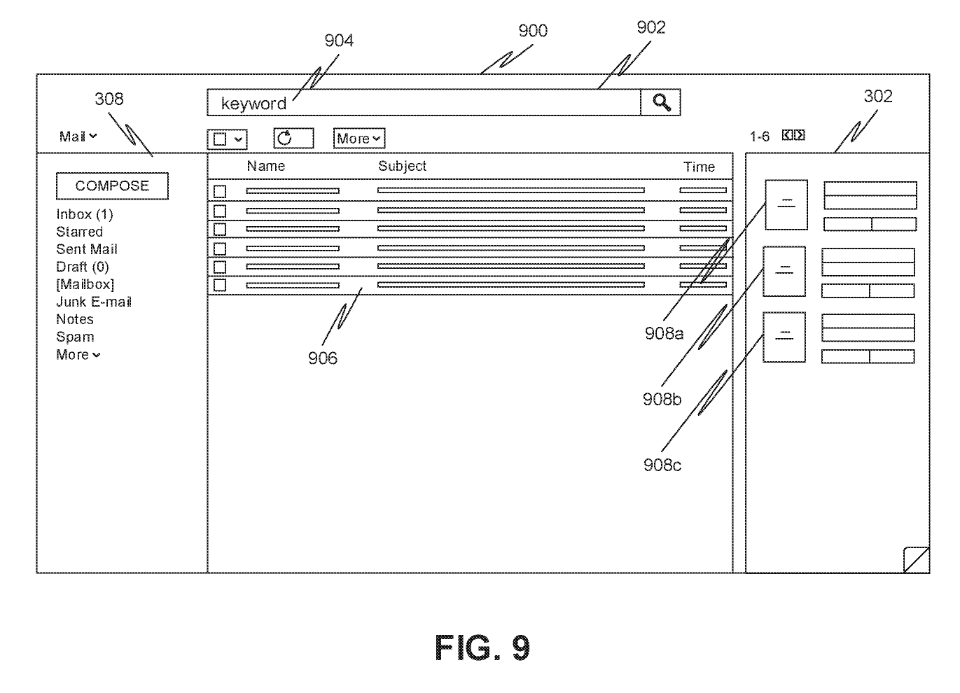

For example, FIG. 9 illustrates a user interface 900 for facilitating searching of digital files associated with one or more storage accounts including a search bar 902, in accordance with some embodiments. Further, the user interface 900 may include an email client interface 308. Furthermore, the user interface 900 may be configured to receive a search criterion 904 in the search bar 902 and display a plurality of identifiers and a corresponding plurality of previews such as, for example, 908a, 908b and 908c within the scrollable feed 302 based on the search criterion 904. Additionally, the user interface 900 may also be configured to display emails 906 corresponding to the search criterion 904 within the email client interface 308.

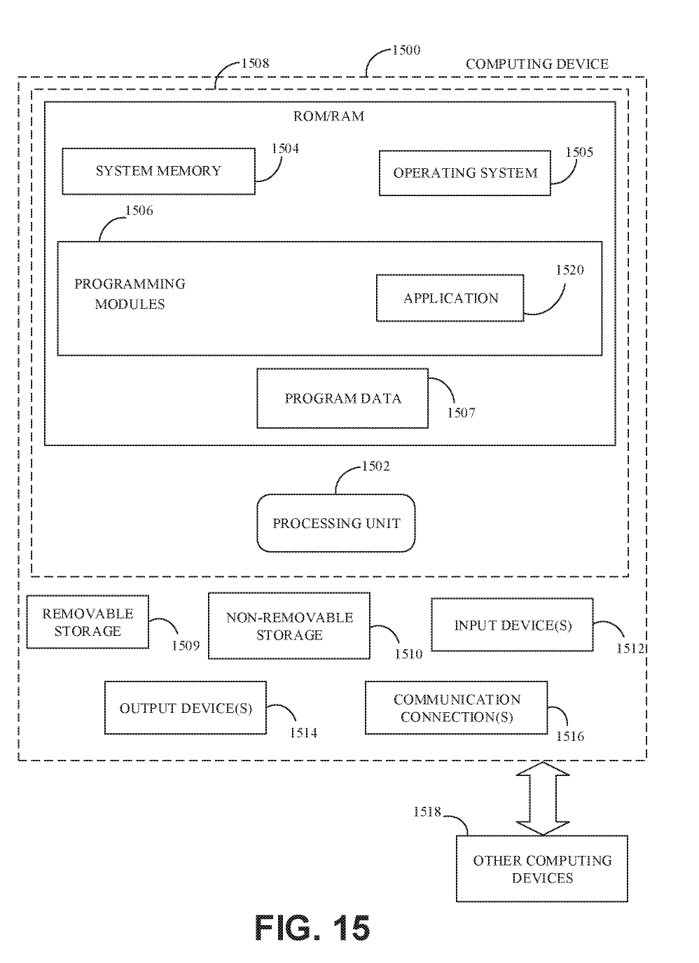

As will be detailed with reference to FIG. 15 below, the computing device through which the online platform may be accessed may comprise, but not be limited to, for example, a desktop computer, laptop, a tablet, or mobile telecommunications device. As will be detailed with reference to FIG. 15 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### III. Platform Operation

Although methods 1000 to 1400 have been described to be performed by platform 100, it should be understood that computing device 1500 may be used to perform the various stages of methods 1000 to 1400. Furthermore, in some embodiments, different operations may be performed by different networked elements in operative communication with computing device 1500. For example, server 110 may be employed in the performance of some or all of the stages in methods 1000 to 1400. Moreover, server 110 may be configured much like computing device 1500.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of methods 1000 to 1400 will be described in greater detail below.

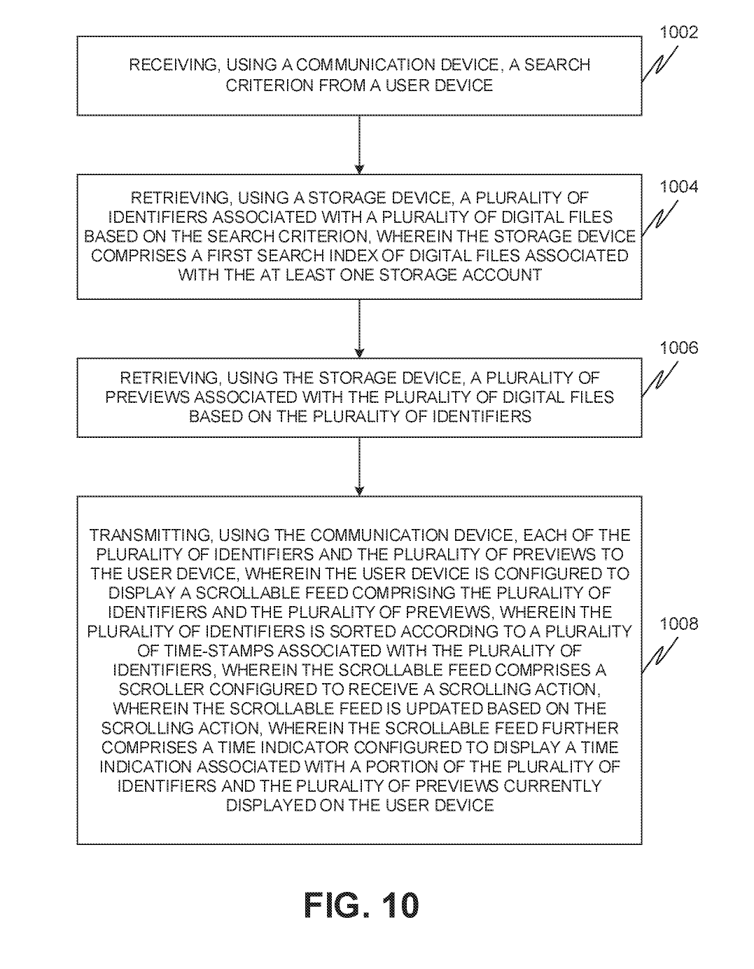

FIG. 10 illustrates a flowchart of a method 1000 of facilitating searching of digital files associated with one or more storage accounts based on a search criterion received from a user device, in accordance with some embodiments. The method 1000 may include a step 1002 of receiving, using a communication device, a search criterion from a user device. In some embodiments, the search criterion may be received within a search interface associated with a storage account of the at least one storage account. Further, the search interface may be configured to initiate a content search for digital content associated with the storage account based on the search criterion. Further, the content search may be performed based on a second search index associated with the storage account.

Further, the method 1000 may include a step 1004 of retrieving, using a storage device, a plurality of identifiers associated with a plurality of digital files based on the search criterion. Further, the storage device may include a first search index of digital files associated with the at least one storage account. Further, the method 1000 may include a step 1006 of retrieving, using the storage device, a plurality of previews associated with the plurality of digital files based on the plurality of identifiers. Further, the method 1000 may include a step 1008 of transmitting, using the communication device, each of the plurality of identifiers and the plurality of previews to the user device. Further, the user device may be configured to display a scrollable feed including the plurality of identifiers and the plurality of previews. Further, the plurality of identifiers may be sorted according to a plurality of time-stamps associated with the plurality of identifiers. Further, the scrollable feed may include a scroller configured to receive a scrolling action. Further, the scrollable feed may be updated based on the scrolling action. Further, the scrollable feed further may include a time indicator configured to display a time indication associated with a portion of the plurality of identifiers and the plurality of previews currently displayed on the user device.

In some embodiments, the method may further include, transmitting, using the communication device, metadata corresponding to the plurality of identifiers. Further, the scrollable feed further may include a plurality of filters based on the metadata. Further, the plurality of filters may be configured to receive a filter selection. Further, a portion of the plurality of identifiers and the plurality of previews may be identified based on the filter selection. Further, the portion of the plurality of identifiers and the plurality of previews may be displayed on the user device.

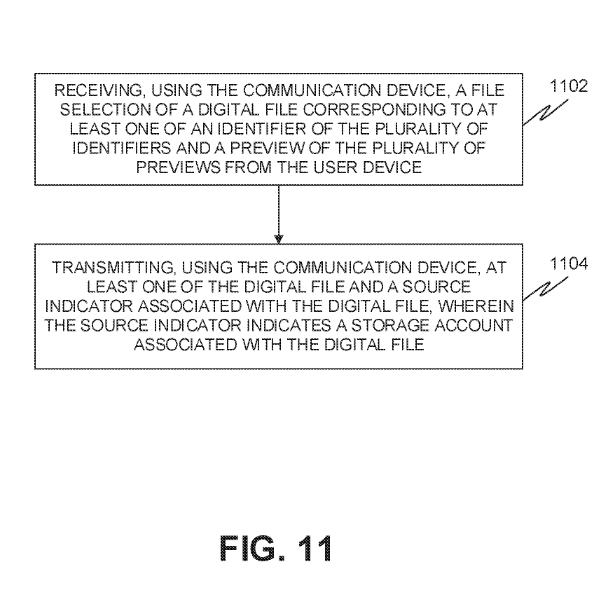

FIG. 11 illustrates a flowchart of a method 1100 of facilitating searching of digital files associated with one or more storage accounts including transmitting full-content of a selected digital file and/or a source indictor of the selected digital file, in accordance with some embodiments. The selected digital file may be identified based on a selection in the scrollable feed comprising the plurality of digital files and the plurality of previews. Further, the source indicator may specify a storage location (e.g. storage account name, file path, email associated with the selected digital file etc.) which includes the selected digital file.

Accordingly, the method 1100 may include a step 1102 of receiving, using the communication device, a file selection of a digital file corresponding to one or more of an identifier of the plurality of identifiers and a preview of the plurality of previews from the user device. Further, the method 1100 may include a step 1104 transmitting, using the communication device, one or more of the digital file and a source indicator associated with the digital file. Further, the source indicator indicates a storage account associated with the digital file.

In some embodiments, the digital file may be associated with at least one email. Further, the source indicator may include indication of the at least one email. In some embodiments, the scrollable feed may include forwarding icon. Further, activation of the forwarding icon causes forwarding of the email to a recipient. Further, the forwarding may be performed by an email client associated with the storage account.

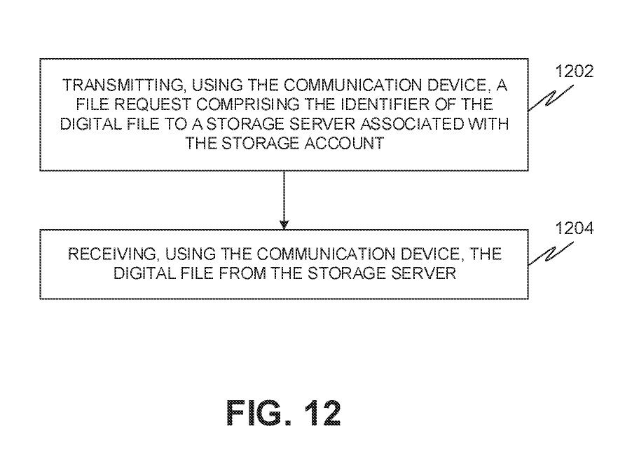

FIG. 12 illustrates a flowchart of a method 1200 of facilitating searching of digital files associated with one or more storage accounts including transmitting of full-content of a digital file based on a file request received from a user device. Further, the method 1200 include transmitting the file request to a storage server and receiving the full-content from the storage server.

Accordingly, the method 1200 may include a step 1202 of receiving, using the communication device, a file request comprising an identifier of a digital file from the user device. Further, the method 1200 may include a step 1204 of transmitting, using the communication device, the file request to a storage server associated with a storage account. Furthermore, the method 1200 may include a step 1206 of receiving, using the communication device, the digital file from the storage server. Additionally, the method 1200 may include a step 1208 of transmitting, using the communication device, the digital file to the user device.

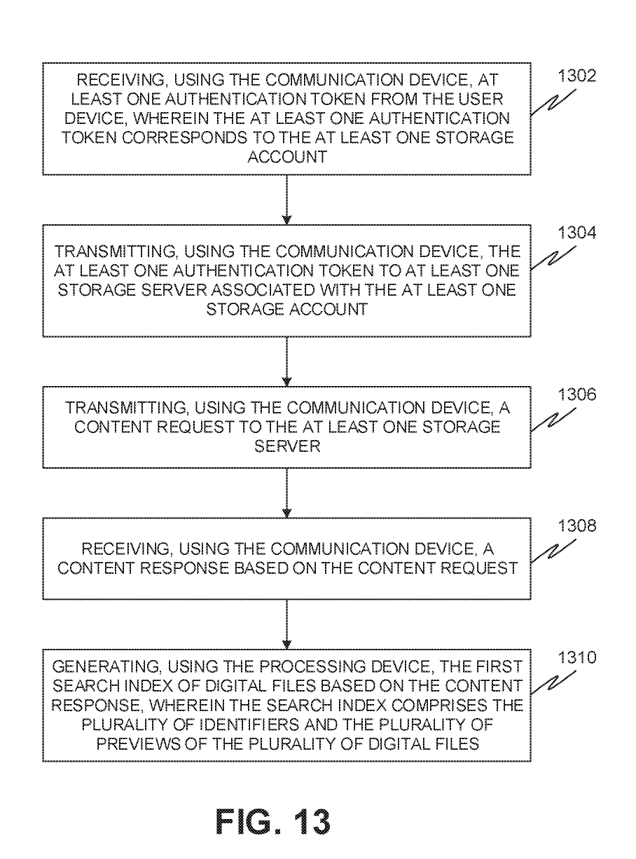

FIG. 13 illustrates a flowchart of a method 1300 of facilitating searching of digital files associated with one or more storage accounts including generation of a search index based on authenticated communication with one or more storage servers associated with one or more storage accounts, in accordance with some embodiments.

Accordingly, the method 1300 may include a step 1302 of receiving, using the communication device, at least one authentication token from the user device. Further, the at least one authentication token corresponds to the at least one storage account. Furthermore, the method 1300 may include a step 1304 of transmitting, using the communication device, the at least one authentication token to at least one storage server associated with the at least one storage account. Additionally, the method 1300 may include a step 1306 of transmitting, using the communication device, a content request to the at least one storage server. Further, the method 1300 may include a step 1308 of receiving, using the communication device, a content response based on the content request. Furthermore, the method 1300 may include a step 1310 of generating, using the processing device, the first search index of digital files based on the content response. Further, the search index may include the plurality of identifiers and the plurality of previews of the plurality of digital files. In some embodiments, the generating of preview associated with a digital file may include creating a visual snapshot of at least a portion of the digital file.

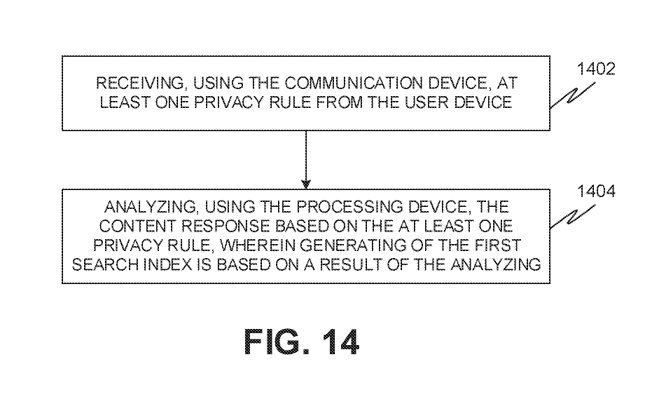

FIG. 14 illustrates a flowchart of a method 1400 of facilitating searching of digital files associated with one or more storage accounts including generation of a search index based on one or more privacy rules, in accordance with some embodiments. Accordingly, the method 1400 may include a step 1402 of receiving, using the communication device, at least one privacy rule from the user device. Further, the method 1400 may include a step 1404 of analyzing, using the processing device, the content response based on the at least one privacy rule. Further, generating of the first search index may be based on a result of the analyzing.

### IV. Platform Architecture

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although methods 1000 to 1400 have been described to be performed by a computing device 1500, it should be understood that, in some embodiments, different operations may be performed by different networked elements in operative communication with computing device 1500.

Embodiments of the present disclosure may comprise a system having a memory storage and a processing unit. The processing unit coupled to the memory storage, wherein the processing unit is configured to perform the stages of methods 1000 to 1400.

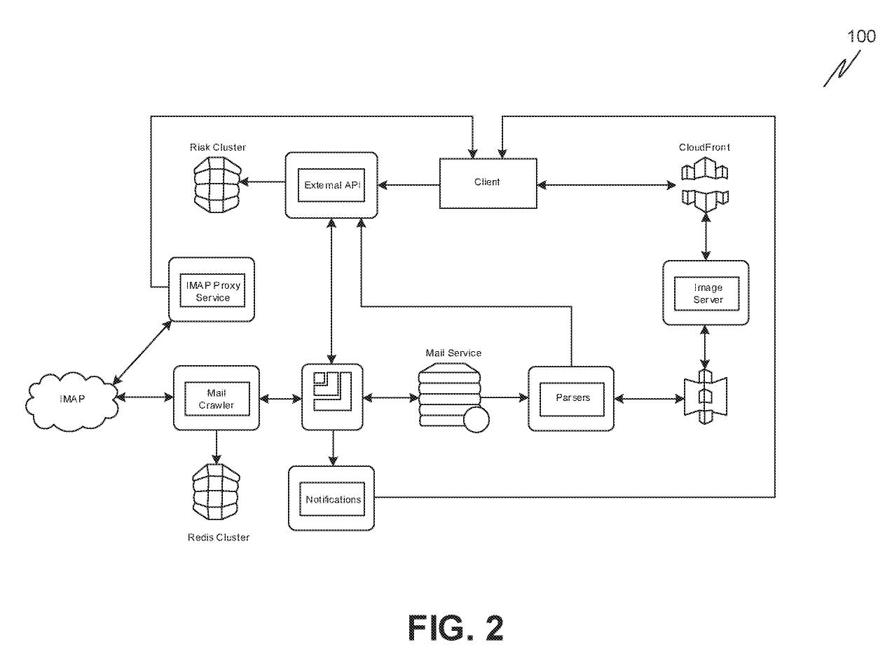

FIG. 2 illustrates a system 200 for facilitating searching of digital files associated with one or more storage accounts, in accordance with some embodiments.

In an instance, the Dittach platform may operate as a series of Node.js clusters that perform specific tasks. These clusters may communicate using a Message Queue (MQ) 212. When a user signs into the system, the plaform authenticates the user against the user's account using XOAUTH2. When making requests, the client 202 (e.g. a web-browser app) may uses a REST API 204 to make information requests. The API 204 may read data from a RIAK DB Cluster (a distributed NoSQL key-value data store), which is a universal access point in the Dittach platform. The platform may use RIAK because it is highly available, extremely scalable, and has a full integration with Apache SOLR, which makes the API-based searches exceptionally performant. When the API 204 needs to trigger other modules in the platform (new account requests, notifications, etc.), it adds a message on the MQ 212 to be consumed by the appropriate service. The Mail Crawler 208 may consume messages about account changes and either triggers, updates, or stops crawling the user's email account for attachments. When the Mail Crawler 208 finds an attachment, it stores the information it finds into a Redis cluster 210. We use Redis cluster 210 because it specializes in performing operations over large data sets. The Mail Crawler 208 then adds a message to the MQ 212 to be consumed by a parsing module 214.

The gateway into the parsing module 214 is a Mail Service 216 which consumes attachment messages from the MQ 212 and, based on their mime-type, sends the attachment to the appropriate Node.js parser. Accordingly, full contents and contextual metadata may be extracted from the attachment and preview images (thumbnails) of the attachments may be generated by the parsing module 214. Further, the parsing module 214 may use the API 204 to store the contents and metadata and put the attachment previews onto a Content delivery Network (CDN) 218. Accordingly, the Dittach platform may not store the actual email attachments, which eliminates a potential security risk and lowers storage costs. When a client 202 requests thumbnails and previews for an attachment, the Dittach platform queries the geographically distributed asset network. For example, if a user is in Italy, their previews are stored in a distributed cache local to Italy in order to speed up future requests. If the asset isn't in the cache, the request is automatically sent to an Image Server 220. The Image Server 220 first queries to see if the assets are in the CDN 218. If not, the Dittach platform may use the attachment preview created by the parser and generate thumbnails on the fly, storing them back into CDN 218 and serving them to the client 202 through the distributed cache system. When a client 202 requests the actual attachment the Dittach platform may use an IMAP proxy service 222 to directly stream the attachment from the user's email account to their device, which is elegant and remarkably efficient.

All clusters in the platform may monitor memory and CPU usage and may scale up and down as appropriate. Should a server become unhealthy or terminate, new nodes in the cluster may automatically take their place. Further, the platform may monitor the log files through New Relic and take periodic incremental snapshots of the data. Each cluster is behind two secure layers of protection from unauthorized access and no credentials are stored on files on the servers, nor in the source code repository. Access to any information, whether it be metadata in the API or attachment previews on the platform, is protected by authorized security tokens, so only the owner of said information has access to their own items. The Dittach platform may employ better-than-industry-standard security practices in its approach to authorization, authentication, and privacy. Dittach's backend may run on Amazon's cloud infrastructure, which meets rigorous compliance standards including HIPAA, FERPA, and NIST 800-171. Further, the Dittach servers may run in a 100% private VPC network, so all Dittach traffic is fully isolated.

The Dittach API may run exclusively over TLS. Unencrypted API connections are rejected. Dittach's internal API communications may also use TLS. TLS uses high-grade AES_128_GCM encryption with perfect forward secrecy via Elliptic Curve Cryptography. For authentication with mail accounts Dittach may use IMAP XOAUTH2. Other email providers, such as Outlook, have adopted the XOAUTH2 extension to IMAP to allow access to email accounts without storing passwords. OAuth also provides the end-user the ability to accept only the permissions necessary and to revoke authorization at any time. The OAuth2 approach generates a “refresh token” for our application that allows us to generate short-lived tokens for logging into the user's email account. Each generated token expires in an hour. The “refresh token” is scoped to the permissions accepted by the user on the OAuth authorization screen. The OAuth refresh tokens are stored in Dittach's database's user records and while they are not themselves encrypted, they are only useful in conjunction with Google application secret, which is not stored in the database. In this way the authentication secrets stored in the database have two layers of protection and database dumps alone would not be sufficient to gain access to user's email accounts. Each device is given a Dittach OAuth token when a user authenticates, which provides authorized access to the user's accounts and related data. These tokens are revocable and unique. Access to the API is not possible without an API token. Database backups are done every hour via Amazon Elastic Block Store snapshots. CDN links to preview assets are served with Cloudfront exclusively over TLS with unique URLs.

FIG. 15 is a block diagram of a system including computing device 1500. Consistent with an embodiment of the disclosure, the aforementioned memory storage and processing unit may be implemented in a computing device, such as computing device 1500 of FIG. 15. Any suitable combination of hardware, software, or firmware may be used to implement the memory storage and processing unit. For example, the memory storage and processing unit may be implemented with computing device 1500 or any of other computing devices 1518, in combination with computing device 1500. The aforementioned system, device, and processors are examples and other systems, devices, and processors may comprise the aforementioned memory storage and processing unit, consistent with embodiments of the disclosure.

With reference to FIG. 15, a system consistent with an embodiment of the disclosure may include a computing device or cloud service, such as computing device 1500. In a basic configuration, computing device 1500 may include at least one processing unit 1502 and a system memory 1504. Depending on the configuration and type of computing device, system memory 1504 may comprise, but is not limited to, volatile (e.g. random access memory (RAM)), non-volatile (e.g. read-only memory (ROM)), flash memory, or any combination. System memory 1504 may include operating system 1505, one or more programming modules 1506, and may include a program data 1507. Operating system 1505, for example, may be suitable for controlling computing device 1500's operation. In one embodiment, programming modules 1506 may include preview generation module and search index generation module. Furthermore, embodiments of the disclosure may be practiced in conjunction with a graphics library, other operating systems, or any other application program and is not limited to any particular application or system. This basic configuration is illustrated in FIG. 15 by those components within a dashed line 1508.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by a removable storage 1509 and a non-removable storage 1510. Computer storage media may include volatile and nonvolatile, removable and non-removable media implemented in any method or technology for storage of information, such as computer readable instructions, data structures, program modules, or other data. System memory 1504, removable storage 1509, and non-removable storage 1510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1500. Any such computer storage media may be part of device 1500. Computing device 1500 may also have input device(s) 1512 such as a keyboard, a mouse, a pen, a sound input device, a touch input device, etc. Output device(s) 1514 such as a display, speakers, a printer, etc. may also be included. The aforementioned devices are examples and others may be used.

Computing device 1500 may also contain a communication connection 1516 that may allow device 1500 to communicate with other computing devices 1518, such as over a network in a distributed computing environment, for example, an intranet or the Internet. Communication connection 1516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1504, including operating system 1505. While executing on processing unit 1502, programming modules 1506 (e.g., application 1520) may perform processes including, for example, stages of one or more of methods 1000 to 1400 as described above. The aforementioned process is an example, and processing unit 1502 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of facilitating searching of digital files associated with at least one storage account, the method comprising:
receiving, using a communication device, a search criterion from a user device;
retrieving, using a storage device, a plurality of identifiers associated with a plurality of digital files based on the search criterion, wherein the storage device comprises a first search index of digital files associated with the at least one storage account;
retrieving, using the storage device, a plurality of previews associated with the plurality of digital files based on the plurality of identifiers; and
transmitting, using the communication device, each of the plurality of identifiers and the plurality of previews to the user device, wherein the user device is configured to display a scrollable feed comprising the plurality of identifiers and the plurality of previews, wherein the plurality of identifiers is sorted according to a plurality of time-stamps associated with the plurality of identifiers, wherein the scrollable feed comprises a scroller configured to receive a scrolling action, wherein the scrollable feed is updated based on the scrolling action, wherein the scrollable feed further comprises a time indicator configured to display a time indication associated with a portion of the plurality of identifiers and the plurality of previews currently displayed on the user device.

2. The method of claim 1 further comprising, transmitting, using the communication device, metadata corresponding to the plurality of identifiers, wherein the scrollable feed further comprises a plurality of filters based on the metadata, wherein the plurality of filters is configured to receive a filter selection, wherein a portion of the plurality of identifiers and the plurality of previews is identified based on the filter selection, wherein the portion of the plurality of identifiers and the plurality of previews is displayed on the user device.

3. The method of claim 1, wherein the search criterion is received within a search interface associated with a storage account of the at least one storage account, wherein the search interface is configured to initiate a content search for digital content associated with the storage account based on the search criterion, wherein the content search is performed based on a second search index associated with the storage account.

4. The method of claim 1 further comprising:
receiving, using the communication device, a file selection of a digital file corresponding to at least one of an identifier of the plurality of identifiers and a preview of the plurality of previews from the user device; and
transmitting, using the communication device, at least one of the digital file and a source indicator associated with the digital file, wherein the source indicator indicates a storage account associated with the digital file.

5. The method of claim 4 further comprising:
transmitting, using the communication device, a file request comprising the identifier of the digital file to a storage server associated with the storage account; and
receiving, using the communication device, the digital file from the storage server.

6. The method of claim 4, wherein the digital file is associated with at least one email, wherein the source indicator comprises indication of the at least one email.

7. The method of claim 6, wherein the scrollable feed comprises forwarding icon, wherein activation of the forwarding icon causes forwarding of the at least one email to a recipient, wherein the forwarding is performed by an email client associated with the storage account.

8. The method of claim 6, wherein the scrollable feed comprises a view-email icon, wherein activation of the view-email icon causes displaying of the at least one email.

9. The method of claim 2, wherein the scrollable feed further comprises a form-factor selector configured to select a form-factor from a plurality of form-factors, wherein the scrollable feed corresponding to a first form-factor consists of the plurality of identifiers and the plurality of metadata, wherein the scrollable feed corresponding to a second form-factor consists of the plurality of previews, wherein the scrollable feed corresponding to a third form-factor consists of each of the plurality of identifiers, the plurality of previews and the plurality of metadata.

10. The method of claim 1 further comprising:
receiving, using the communication device, at least one authentication token from the user device, wherein the at least one authentication token corresponds to the at least one storage account;
transmitting, using the communication device, the at least one authentication token to at least one storage server associated with the at least one storage account;
transmitting, using the communication device, a content request to the at least one storage server;
receiving, using the communication device, a content response based on the content request; and
generating, using the processing device, the first search index of digital files based on the content response, wherein the search index comprises the plurality of identifiers and the plurality of previews of the plurality of digital files.

11. The method of claim 10, wherein the generating of preview associated with a digital file comprises creating a visual snapshot of at least a portion of the digital file.

12. The method of claim 10 further comprising:
receiving, using the communication device, at least one privacy rule from the user device; and
analyzing, using the processing device, the content response based on the at least one privacy rule, wherein generating of the first search index is based on a result of the analyzing.

13. A system for facilitating searching of digital files associated with at least one storage account, the system comprising:
a. a communication device configured to:
receive a search criterion from a user device; and
transmitting, using the communication device, each of a plurality of identifiers and a plurality of previews to the user device, wherein the user device is configured to display a scrollable feed comprising the plurality of identifiers and the plurality of previews, wherein the plurality of identifiers is sorted according to a plurality of time-stamps associated with the plurality of identifiers, wherein the scrollable feed comprises a scroller configured to receive a scrolling action, wherein the scrollable feed is updated based on the scrolling action, wherein the scrollable feed further comprises a time indicator configured to display a time indication associated with a portion of the plurality of identifiers and the plurality of previews currently displayed on the user device; and
b. a storage device configured to:
retrieve the plurality of identifiers associated with the plurality of digital files based on the search criterion, wherein the storage device comprises a first search index of digital files associated with the at least one storage account; and
retrieve the plurality of previews associated with the plurality of digital files based on the plurality of identifiers.

14. The system of claim 13, wherein the communication device is further configured to transmit metadata corresponding to the plurality of identifiers, wherein the scrollable feed further comprises a plurality of filters based on the metadata, wherein the plurality of filters is configured to receive a filter selection, wherein a portion of the plurality of identifiers and the plurality of previews is identified based on the filter selection, wherein the portion of the plurality of identifiers and the plurality of previews is displayed on the user device.

15. The system of claim 13, wherein the search criterion is received within a search interface associated with a storage account of the at least one storage account, wherein the search interface is configured to initiate a content search for digital content associated with the storage account based on the search criterion, wherein the content search is performed based on a second search index associated with the storage account.

16. The system of claim 13, wherein the communication device is further configured to:
receive a file selection of a digital file corresponding to at least one of an identifier of the plurality of identifiers and a preview of the plurality of previews from the user device; and
transmit at least one of the digital file and a source indicator associated with the digital file, wherein the source indicator indicates a storage account associated with the digital file.

17. The system of claim 16, wherein the communication device is further configured to:
transmit a file request comprising the identifier of the digital file to a storage server associated with the storage account; and
receive the digital file from the storage server.

18. The system of claim 16, wherein the digital file is associated with at least one email, wherein the source indicator comprises indication of the at least one email.

19. The system of claim 6, wherein the scrollable feed comprises forwarding icon, wherein activation of the forwarding icon causes forwarding of the at least one email to a recipient, wherein the forwarding is performed by an email client associated with the storage account.

20. The system of claim 18, wherein the scrollable feed comprises a view-email icon, wherein activation of the view-email icon causes displaying of the at least one email.

21. The system of claim 14, wherein the scrollable feed further comprises a form-factor selector configured to select a form-factor from a plurality of form-factors, wherein the scrollable feed corresponding to a first form-factor consists of the plurality of identifiers and the plurality of metadata, wherein the scrollable feed corresponding to a second form-factor consists of the plurality of previews, wherein the scrollable feed corresponding to a third form-factor consists of each of the plurality of identifiers, the plurality of previews and the plurality of metadata.

22. The system of claim 13, wherein the communication device is further configured to:
receive at least one authentication token from the user device, wherein the at least one authentication token corresponds to the at least one storage account;
transmit the at least one authentication token to at least one storage server associated with the at least one storage account;
transmit a content request to the at least one storage server; and
receive a content response based on the content request, wherein the system further comprises a processing device configured to generate the first search index of digital files based on the content response, wherein the search index comprises the plurality of identifiers and the plurality of previews of the plurality of digital files.

23. The system of claim 22, wherein the generation of preview associated with a digital file comprises creating a visual snapshot of at least a portion of the digital file.

24. The system of claim 22, wherein the communication device is further configured to receive at least one privacy rule from the user device, wherein the processing device is further configured to analyze the content response based on the at least one privacy rule, wherein generation of the first search index is based on a result of the analyzing.
